(19) United States
(12) Patent Application Publication
(10) Pub. No.: US 2015/0085796 A1
(43) Pub. Date: Mar. 26, 2015

(54) FLEXIBLE OPERATION OF ENHANCED TTI-BUNDLING MODES IN LTE

(71) Applicant: QUALCOMM Incorporated, San Diego, CA (US)

(72) Inventors: Hao XU, San Diego, CA (US); Madhavan Srinivasan VAJAPEYAM, San Diego, CA (US); Wanshi CHEN, San Diego, CA (US); Peter GAAL, San Diego, CA (US)

(21) Appl. No.: 14/490,583

(22) Filed: Sep. 18, 2014

Related U.S. Application Data
(60) Provisional application No. 61/880,820, filed on Sep. 20, 2013.

(51) Int. Cl. H04W 72/04; H04L 1/16; H04L 1/18

(52) U.S. Cl. CPC H04W 72/0493; H04L 1/1887; H04L 1/16
USPC 370/329

(57) ABSTRACT

A method, an apparatus, and a computer program product for wireless communication are provided. At least two hybrid automatic repeat request (HARQ) processes are selected from among a plurality of HARQ processes within a round trip time. The at least two selected HARQ processes are combined to transmit the same data in a combined transmission. The at least two selected HARQ processes may be continuous within the round trip time, or offset within the round trip time. In the case of offset HARQ processes, the offset between the at least two selected HARQ processes may allow for early termination of the combined transmission. For example, an ACK of a first of the selected HARQ processes may terminate the transmission of a second of the selected HARQ processes.

### CROSS-REFERENCE TO RELATED APPLICATION(S)

This application claims the benefit of U.S. Provisional Application Ser. No. 61/880,820, entitled “Flexible Operation of Enhanced TTI-Bundling Modes In LLE” and filed on Sep. 20, 2013, which is expressly incorporated by reference herein in its entirety.

### BACKGROUND

1. Field

The present disclosure relates generally to communication systems, and more particularly, to flexible operation of enhanced transmission time interval (TTI) bundling modes in LTE.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

A method, an apparatus, and a computer program product for wireless communication are provided. At least two hybrid automatic repeat request (HARQ) processes are selected from among a plurality of HARQ processes within a round trip time. The at least two selected HARQ processes are combined to transmit the same data in a combined transmission. The at least two selected HARQ processes may be continuous within the round trip time, or offset within the round trip time. In the case of offset HARQ processes, the offset between the at least two selected HARQ processes may allow for early termination of the combined transmission. For example, an ACK of a first of the selected HARQ processes may terminates the transmission of a second of the selected HARQ processes.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating an example of Release 8 TTI bundling.

FIG. 8 illustrates an example of a modified TTI-B bundling with a semi-persistent scheduling (SPS) activation cycle of 20 ms.

FIG. 9A illustrates an example of an embodiment selecting and combining HARQ process bundles #0 and #1.

FIG. 9B illustrates an example of an embodiment selecting and combining HARQ process bundles #0 and #3.

FIG. 10 is another view of the example of an embodiment selecting and combining HARQ process bundles #0 and #3.

FIG. 11 is a flow chart of a method of wireless communication.

FIG. 12 is a conceptual data flow diagram illustrating the data flow between different modules/means/components in an exemplary apparatus.

FIG. 13 is a diagram illustrating an example of a hardware implementation for an apparatus employing a processing system.

FIG. 14 is a diagram illustrating an embodiment with non-continuous HARQ process bundles.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise on-chip registers, a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

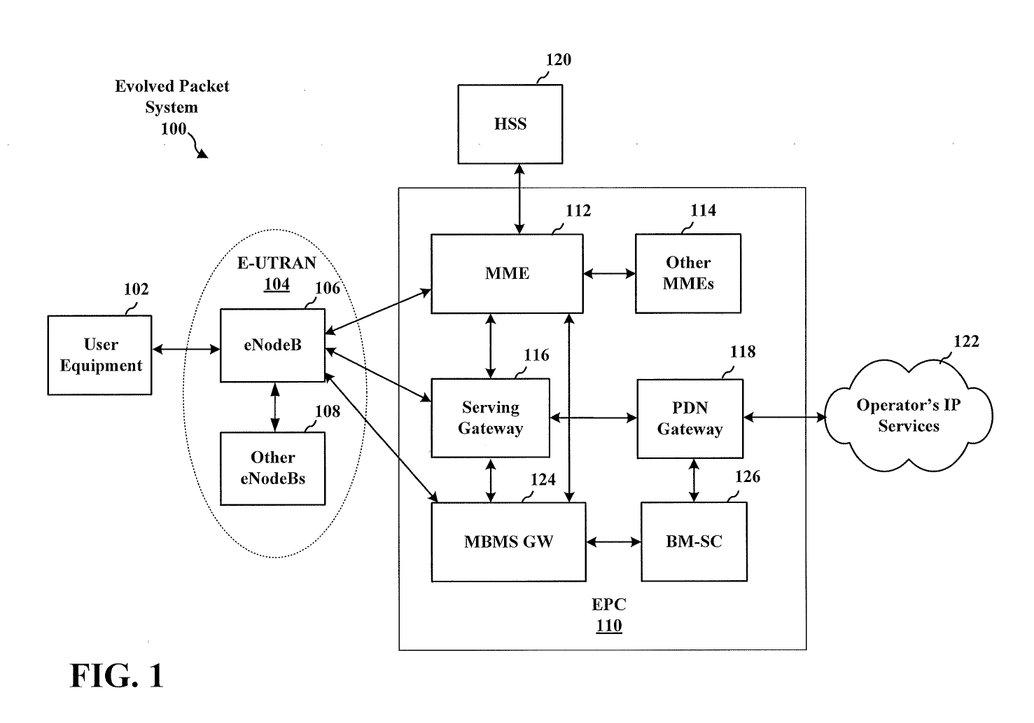

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

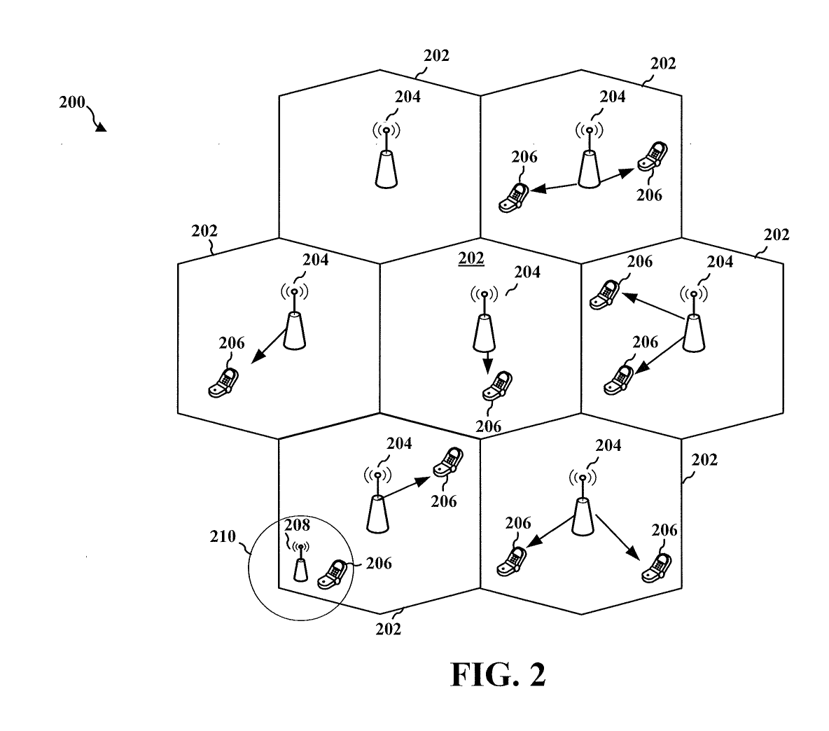

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

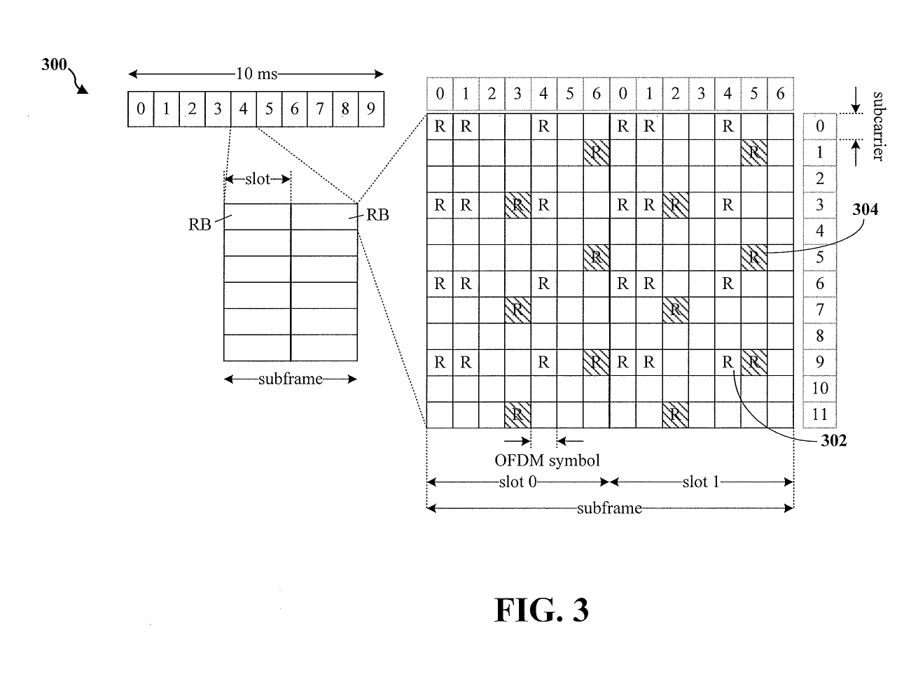

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

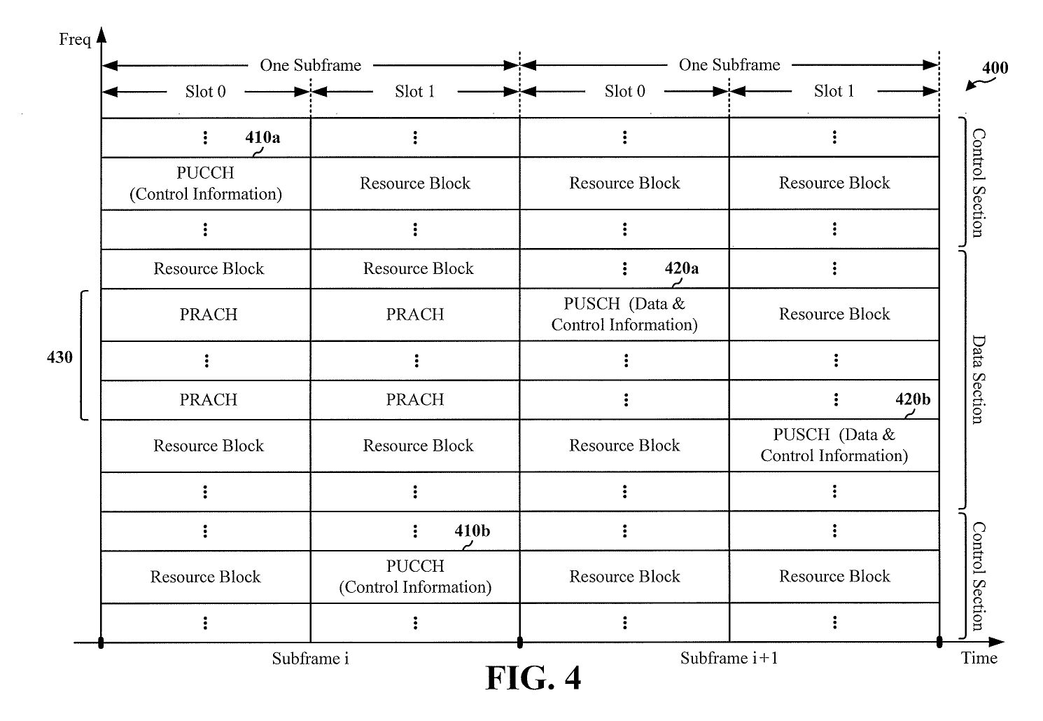

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

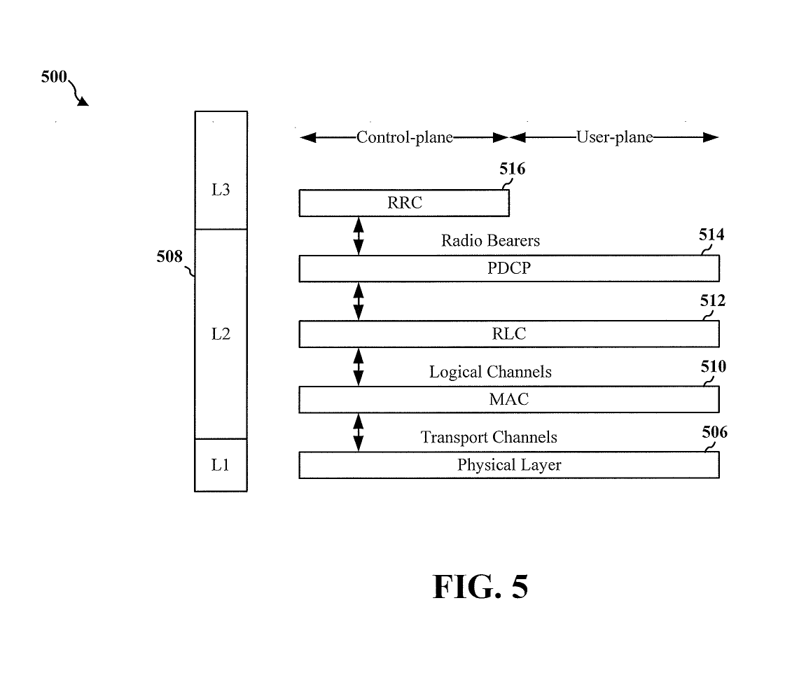

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

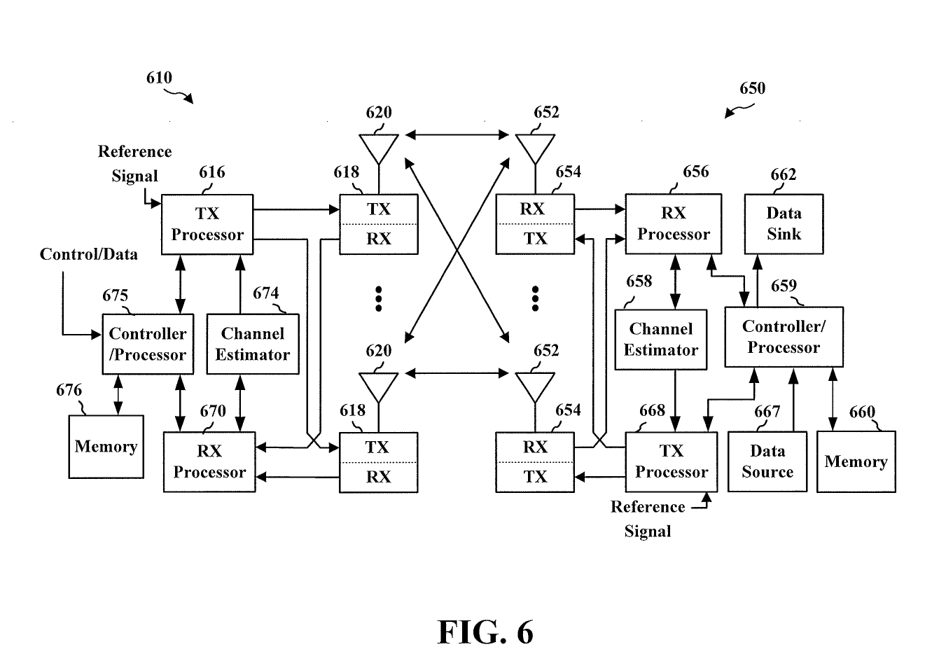

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

Examples of HARQ process described below relate to uplink processes. Such processes, however, would function in like fashion in a downlink.

HARQ is an error correction mechanism used in LTE. A data block (e.g., packets) is encoded with, e.g., forward error correction code. A UE transmits the encoded data block, and waits for ACK/NACK feedback from the eNB. If NACK is received, indicating that the data block decoded by the eNB includes errors, the UE retransmits a redundancy version (RV) of the encoded data block. A redundancy version is the same block of data that is encoded differently, allowing the eNB to decode each RV independently. In LTE, there may be up to four RVs for each data block. If ACK is received, indicating that the eNB has decoded the data block successfully, the UE stops the retransmission process. The foregoing process of transmitting encoded data, waiting for ACK/NACK and retransmitting an RV in the case of NACK or stopping retransmission in case of ACK, is referred to as a HARQ process.

Each HARQ transmission takes one subframe. The HARQ round trip time (RTT) is 8 subframes. For example, it takes 4 subframes for an eNB to receive an encoded data block transmitted by a UE, decode the encoded data block and transmit ACK/NACK feedback. It takes another 4 subframes for the UE to receive the ACK/NACK feedback transmitted by the eNB and determine whether to retransmit an RV of the encoded data block.

To improve throughput, multiple HARQ processes—each for a different data block, payload—may be engaged in parallel. For example, at the first subframe, the UE may transmit a first encoded data block. At the second subframe, the UE may transmit a second encoded data block different from the first encoded data block, and so forth. Because the RTT is 8 subframes, up to 8 HARQ processes for 8 different data blocks may be perform in parallel. At the ninth subframe, the UE may need to retransmit a RV of the first encoded the data block.

LTE Release 8 (Rel-8) introduced transmission time interval (TTI) bundling mode (TTI-B) to improve coverage. A TTI is, for example, 1 ms. Thus, TTI generally corresponds to one subframe. A TTI is a unit of time, whereas a subframe further includes a frequency component. For example, UEs are link budget-limited and would benefit from TTI bundling. Without bundling, 8 HARQ processes {#0, . . . , #7} can be supported with a RTT of 8 ms.

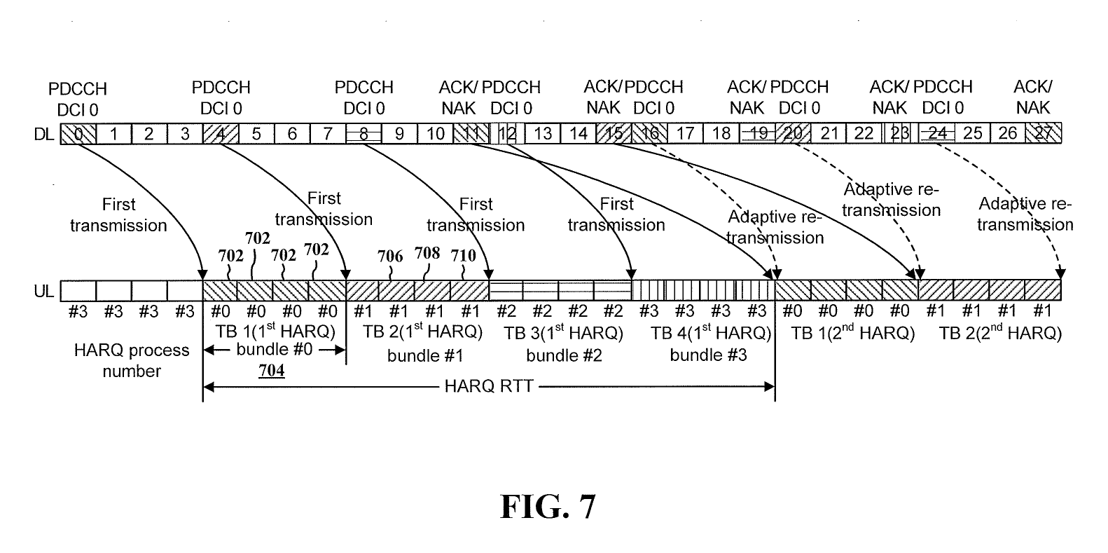

With reference to FIG. 7, in TTI-bundling, a UE transmits new HARQ RVs without waiting for HARQ feedback from the eNB. As shown in FIG. 7, four TTIs 702 are grouped or bundled together for each of four different data blocks. Each of the group or bundle of TTIs defined a TTI bundle 704. Each of the TTIs 702 within a TTI bundle 704 may be used to transmit a different RV of the data block. Thus, instead of transmitting the data block or its RV every 8 TTIs, the data block and/or the RVs are transmitted over four consecutive TTIs 702. The transmissions of the four consecutive TTIs constitute a transport block (TB). An example TB includes 382 bits of data. FIG. 7 illustrates four different HARQ process bundles {#0, #1, #2, and #3} for transmitting four different TBs, each TB corresponding to a different data block and RVs thereof. Up to four HARQ process bundles are available in Rel-8 TTI-B and therefore, transmission of up to 4 TBs can be interleaved in time. In this example, the RTT is 16 ms.

By using bundling, the control overhead of HARQ process is reduced and delay performance is improved. However, the early termination gain is reduced. In one aspect, early termination is a case where an ACK feedback is received before the next RV is transmitted. Thus, the UE can stop the transmission. For example, with reference to HARQ process bundle #1 in FIG. 7, the eNB may accurately decode the data block after the second transmitted subframe 706 of the HARQ process bundle. However, in this case, RVs of the data block are still transmitted in the third and fourth subframes 708, 710 of the HARQ process bundle.

Rel-8 TTI-B includes other limitations. As discussed above, the HARQ RTT is 16 ms, which is too long. Further, there is a lack of flexibility in Rel-8 TTI-B in that only four TTIs can be bundled. Moreover, if a UE is configured with TTI-B, then all of the UE's PUSCH transmissions are bundled.

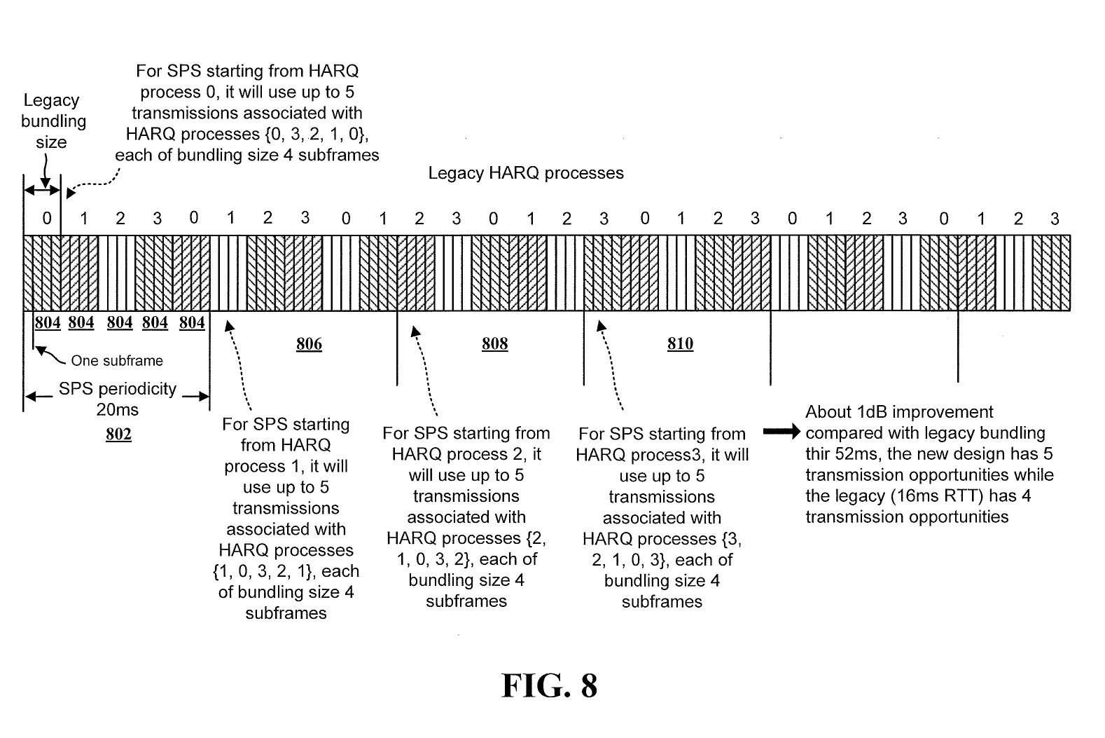

FIG. 8 illustrates an example of a modified TTI-B bundling with a semi-persistent scheduling (SPS) activation cycle of 20 ms. In SPS, a UE obeys a scheduling grant that is given earlier, until the scheduling grant is canceled. SPS schedules a cycling, persistent physical resource block (PRB) allocation (cyclical) for uplink or downlink. Without SPS, every uplink or downlink PRB allocation needs to be granted via an access grant message on the PDCCH. SPS significantly reduces overhead.

In the example of FIG. 8, a SPS cycle 802 includes five HARQ process bundles 804. For an SPS cycle 802 starting from HARQ process #0, the SPS cycle includes five transmissions associated with HARQ process bundles {#0, #3, #2, #1, #0}, each bundle including four subframes. For an SPS cycle 806 starting from HARQ process #1, the SPS cycle includes five transmissions associated with HARQ process bundles {#1, #0, #3, #2, #1}, each bundle including four subframes. For an SPS cycle 808 starting from HARQ process #2, the SPS cycle includes five transmissions associated with HARQ process bundles {#2, #1, #0, #3, #2}, each bundle including four subframes. For an SPS cycle 810 starting from HARQ process #3, the SPS cycle includes five transmissions associated with HARQ process bundles {#3, #2, #1, #0, #3}, each bundle including four subframes. In this example, the RTT is 12 ms.

One of the enhancements considered in LTE Release 12 (Rel-12) is to increase the number of TTIs in a bundle to more than four. One proposed approach that limits the impact on legacy UE operation is to start multiple HARQ process bundles for the same transport block.

In one aspect, the process disclosed herein provides improvement based on the legacy or existing HARQ process bundles (e.g., a bundle of 4 TTIs) by further bundling or combining the legacy or existing HARQ process bundles to transmit the same payload or data. For example, the selected legacy HARQ process bundles may transmit a same TB. In one aspect, the same payload may be transmitted using a selected number of HARQ process bundles. For example, two, three or four legacy or existing HARQ process bundles may be selected and combined. Combined in this sense means that the selected HARQ process bundles transmit the same data. In the case of selection of two HARQ process bundles, this effectively yields TTI bundling of eight subframes. As a result, impact of this improvement is minimized as the granularity and timeline is closely matching of 4-TTI bundling

Several aspects of such enhanced TTI-B operations are describe below. These enhanced TTI-B operations improve, inter alia, the flexibility of TTI bundling. In one aspect, the selection of which HARQ process bundles to combine is based on a predetermined algorithm or paradigm. In one aspect, two HARQ process bundles are selected. Selection of which two HARQ processes to combine can be done in several ways. For example, adjacent numbered HARQ process bundles, e.g., {#0, #1} or {#2, #3}, may be selected. This selection provides continuous bundle transmission, but less time diversity and no early termination benefit.

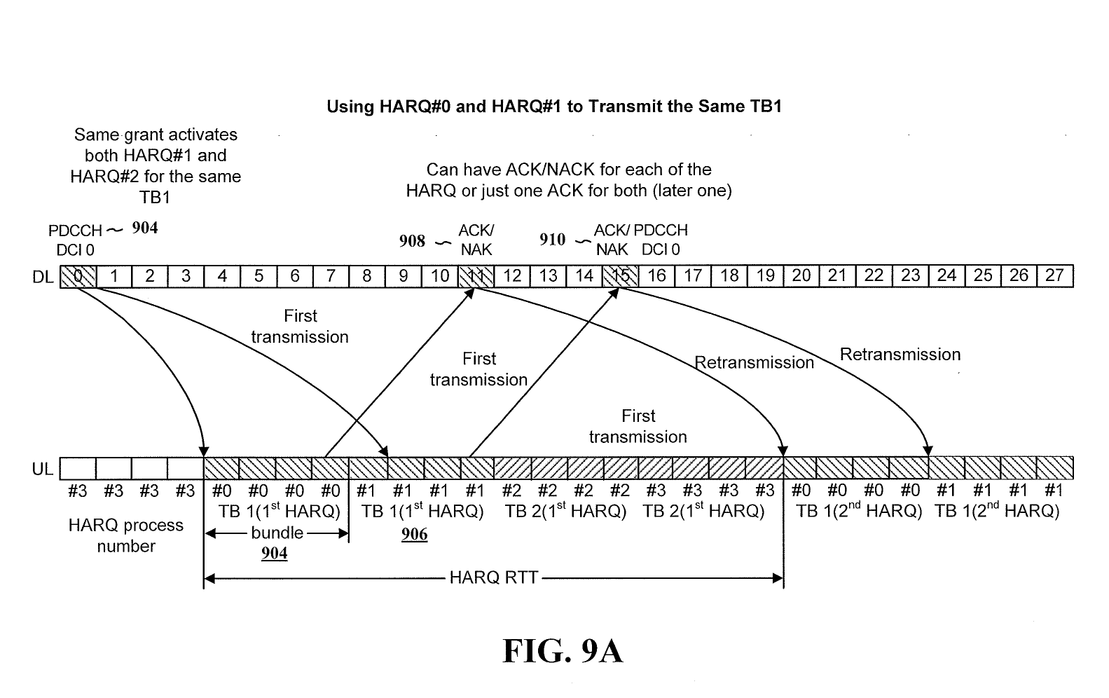

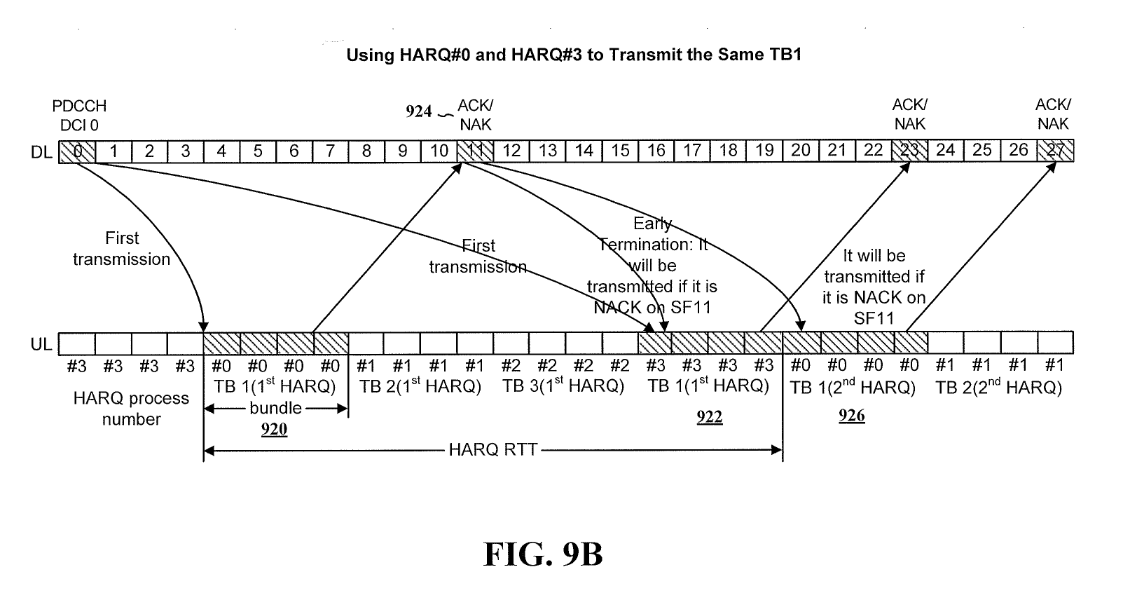

An example enhanced TTI bundling operation is illustrated in FIG. 9A. As shown, the same PDCCH 902 may be used to activate two adjacent numbered HARQ process bundles 904, 906 to transmit the same payload TB 1. In one aspect, separate ACK/NACK feedbacks 908, 910 are used for each HARQ process bundle 904, 906. In another aspect, one ACK/NACK feedback is used for both HARQ process bundles 904, 906.

In another example of an enhanced TTI bundling operation, as illustrated in FIG. 9B, offset numbered HARQ process bundles 920, 922, e.g., {#0, #3}, are selected to transmit the same payload TB1. In this example, early termination is possible. An ACK feedback 924 received on one of the selected HARQ process bundles 920, e.g., #0, may terminate the other selected HARQ process bundle 922, e.g., #3. The same ACK feedback 924 may terminate the second HARQ process bundle 926, e.g., #0, of the same payload TB 1. A NACK feedback 924 results in transmission of the other selected HARQ process bundle 922, e.g., #3, and the second HARQ process bundle 926, e.g., #0. In another example, HARQ process bundles {#0, #2} may be selected (not illustrated). In this example, no early termination gain results, but some time diversity gain is achieved.

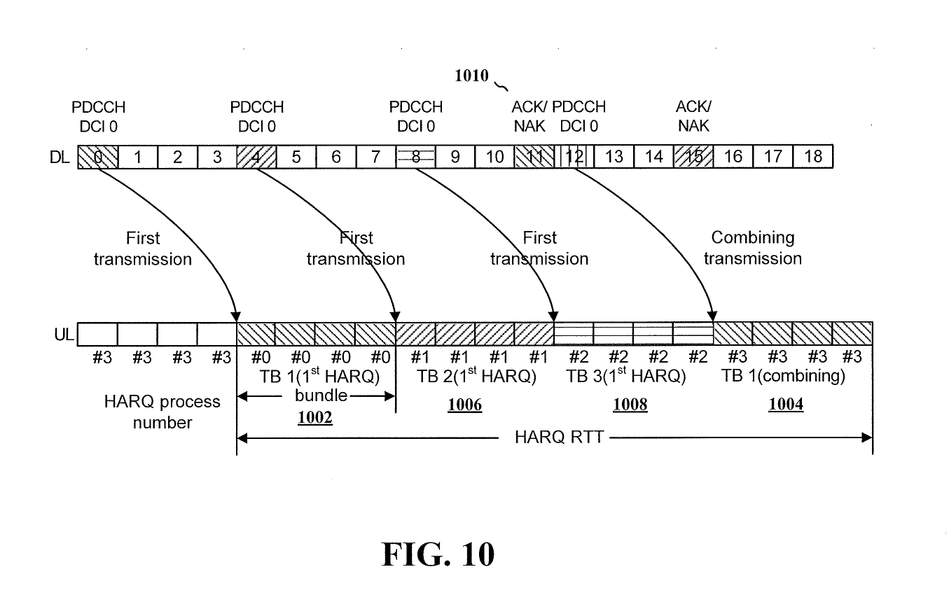

Early termination means PHICH (which carries the ACK/NACK feedback) for the previous transmission is available at or before the scheduling subframe for the next transmission. FIG. 10 illustrates an example of early termination wherein HARQ process bundles 1002, 1004, e.g., {#0, #3}, are selected to combine but HARQ process bundles 1006, 1008, e.g., {#1, #2}, are not selected to combine. As shown, ACK/NACK feedback 1010 on PHICH for HARQ process bundle #0 1002 is available in subframe 11, before the combined HARQ process bundle process #3 1004 transmitting the same TB as HARQ process bundle #0 1002 is scheduled for transmission. The UE therefore can terminate the transmission of HARQ process bundle process #3 1004 early. In one aspect, the selection of HARQ process bundles {#0, #3} may be advantageous if early termination is desired.

In another aspect, three or more HARQ process bundles may be selected for combination. In one example, Layer 3 (Network layer) configures the HARQ processes to be combined. In one example, Radio Resource Control (RRC) configures the HARQ processes to be combined. In one aspect, RRC configures one of the following examples: Two HARQ process bundles are selected with a gap or offset of three (3). That is, HARQ process bundles N and N+3 (in a cycle of 0-3) are selected. Thus, HARQ process bundles {#0, #3}, {#1, #0}, {#2, #1}, {#3, #2} are selected. Choice of which among the sets to select may depend on the SPS activation subframe. For example, if the SPS activation subframe is at bundle #2, then the set {#2, #1} would be selected.

In one aspect, three HARQ process bundles may be selected with gaps or offsets of 1 and 3. That is, HARQ process bundles N, N+1, and N+3 (in a cycle of 0-3) are selected. Thus, the selected processes may be the following sets:

{#0,#1,#3}, {#1,#2,#0}, {#2,#3,#1}, {#3,#0,#2}.

Choice of which among the above sets to select may depend on the SPS activation subframe. For example, if the SPS activation subframe is at bundle #2, then the set {#2, #3, #1} would be selected. In another aspect, all four HARQ process bundles {#0, #1, #2, #3} are selected.

In one aspect, the selection and combination processes discussed above may operate with SPS (e.g., uplink SPS). For example, in a case where UL SPS is not configured, a UE may use a fixed bundle size as configured by upper layers (e.g., RRC). Rel-12 may be configured with four TTI-B (as in Rel-8) or with the HARQ combining mode.

In a case where UL SPS is configured, the bundle size for the SPS transmission may be different from the non-SPS (dynamic scheduling or DS) transmission. This allows better coverage for VoIP traffic.

In one aspect, options of the selection and combination process and SPS activation are provided. In one case, SPS activation may implicitly control selection of the HARQ process bundles to be combined. The HARQ process bundle in which a SPS activation subframe occurs is a first of the selected HARQ process bundles. A second selected HARQ process bundle may be a fixed offset(s) from the first selected HARQ process bundle. For example, if offset=3, and SPS activation occurs in the subframe corresponding to process bundle #0, then the selected HARQ process bundles correspond to HARQ process bundles {#0, #3}.

In another case, SPS activation may explicitly control selection of the HARQ process bundles. Here, there is an indication of which HARQ processes to select for combination regardless of when the SPS activation occurs. In one aspect, the selected HARQ processes may be indicated through upper layer signaling, e.g., RRC or MAC PDU, or with SPS activation by a control information (DCI) message. In one aspect, Rel-8 specifications provide that SPS may be activated and re-configured via DCI message.

In one aspect, selection of HARQ processes for combining based on SPS may be overridden with dynamic scheduling (DS), wherein a new HARQ process may be granted by the DS. When SPS is overridden by a dynamic grant, all of the HARQ process selections based on SPS may be cleared and a new HARQ process selection corresponding to the dynamic grant started. In another implementation, the HARQ process selections based on SPS are cleared and multiple combining HARQ processes are started. By combining multiple HARQ processes the following is meant: if HARQ process 1 is transmitted in T0, HARQ process 2 is transmitted in T0+1, then combining two HARQ processes into one means it is now transmitted in bundled fashion spanning T0 to T0+1. In yet another implementation, only one SPS process is cleared, while the other is kept.

Certain aspects of the RACH operation, and particularly the msg3 operation are discussed below. Msg3 is part of the RACH procedure in LTE. In one aspect, msg3 carries the RRC CONNECTION REQUEST message from UE. For msg3 transmission, the options include:

(1) Retain Rel-8 mode (no additional bundling allowed).

(2) Enable bundling for msg3, and use the dynamic scheduling bundling size.

In one aspect, the existing or legacy HARQ process bundles may be continuous, as discussed above. For example, in FIG. 7, each existing or legacy HARQ process bundle occupies four continuous subframes.

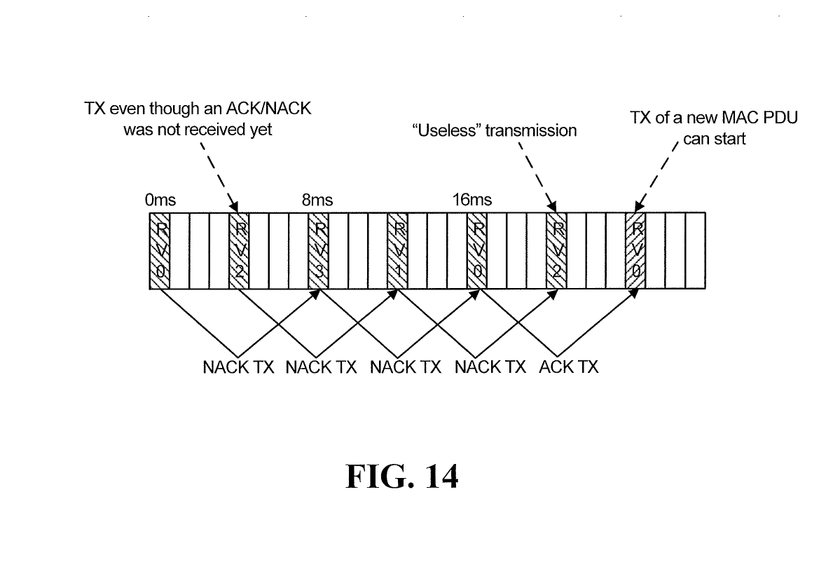

In another aspect, the existing or legacy HARQ process bundles may be discontinuous (the subframes are not continuous). In yet another aspect, the HARQ processes used in the HARQ process combining may not be bundled originally. FIG. 14 illustrates an example of these features. In this example, the existing or legacy HARQ process bundles are discontinuous. For example, the first subframe is part of the HARQ process bundle #0; the second subframe is part of the HARQ process bundle #1; and so forth. FIG. 14 illustrates a case where the existing or legacy HARQ process bundles #1 and #4 are combined, and each subframe of the combined HARQ process bundles is offset by 3. In this example, the original HARQ process is not bundled, i.e. there are 8 HARQ processes as in Rel-8. The example illustrates that the combined two HARQ process bundles with 8 ms RTT allows for early termination for FDD.

For TDD, when different HARQ processes are combined, the same principle may apply. It is especially useful to allow combining of TDD HARQ processes or HARQ process bundles. Currently, only selected TDD configurations are supporting TTI bundling. With the new combined HARQ approach, such bundling can be applied to all TDD configurations without much impact on HARQ timeline. So both FDD and TDD would share the same design philosophy.

In another aspect, the combination may include both continuous HARQ process bundles and non-continuous HARQ process bundles. In yet another aspect, the combination may include both bundled HARQ process and non-bundled HARQ processes. For example, the combined HARQ process may transmit for four continuous subframes, then start discontinuous transmission.

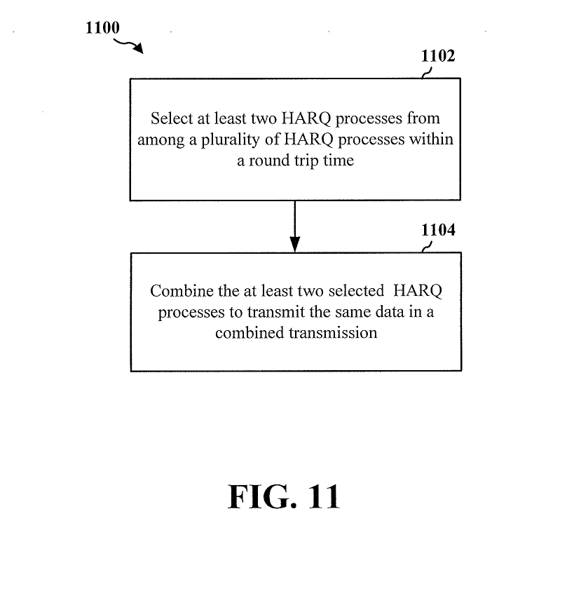

FIG. 11 is a flow chart 1100 of a method of wireless communication. The method may be performed by a UE. At step 1102, the UE selects at least two HARQ processes from among a plurality of HARQ processes within a round trip time. The at least one of the selected HARQ processes may be a TTI-bundled HARQ process. The at least two selected HARQ processes may be continuous within the round trip time, such as shown in FIG. 9A, or offset within the round trip time, such as shown in FIG. 9B. The offset between the at least two selected HARQ processes may allow early termination of the combined transmission. For example, with reference to FIG. 9B, an ACK 924 of a first of the selected HARQ processes 920 may terminate the transmission of a second of the selected HARQ processes 922.

The UE may select the at least two HARQ processes by receiving signaling that indicates the at least two selected HARQ processes. For example, the received signaling may be upper layer signaling, such as RRC signaling, that explicitly identifies the at least two selected HARQ processes. In the case of SPS, the received signaling may include a SPS activation signal. Here, a first of the at least two selected HARQ process may correspond to the HARQ process having a subframe in which the SPS activation occurred, and a second of the at least two selected HARQ processes may correspond to a HARQ process that is offset from the first selected HARQ process by an offset value. In the case of dynamic scheduling, selecting may further include receiving a grant for HARQ process through dynamic scheduling; and overriding at least part of the HARQ process signal selection based on SPS.

At step 1104, the UE combines the at least two selected HARQ processes to transmit the same data in a combined transmission. Combining the at least two selected HARQ processes may include receiving a downlink grant for a HARQ process and activating the at least two selected HARQ processes for the same data based on the downlink grant.

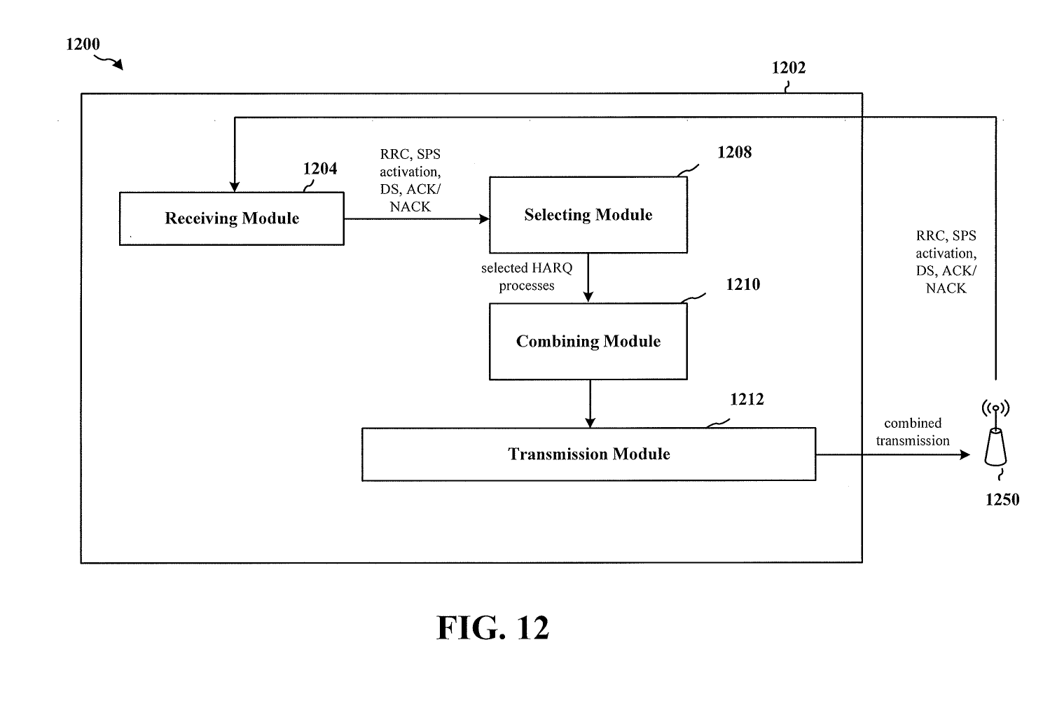

FIG. 12 is a conceptual data flow diagram 1200 illustrating the data flow between different modules/means/components in an exemplary apparatus 1202. The apparatus may be a UE. The apparatus 1202 includes a receiving module 1204, a selecting module 1208, a combining module 1210, and a transmission module 1212.

The receiving module receives signals from an eNB 1250 related to the selection of HARG processes for combining in accordance with the method of FIG. 11. For example, the receiving module 1204 may receive upper layer signaling, e.g., RRC signaling that indicates which HARQ processes to select. Other signaling may include SPS signaling, such as an activation signal, or dynamic scheduling (DS) signaling.

The selection module 1208, selects at least two HARQ processes from among a plurality of HARQ processes within a round trip time. Selection may be based on the signals received by the receiving module 1204.

The combining module 1210 combines the at least two selected HARQ processes to transmit the same data in a combined transmission. The transmitting module 1212 transmits the selected HARQ processes in accordance with the combined transmission.

The apparatus may include additional modules that perform each of the steps of the algorithm in the aforementioned flow chart of FIG. 11. As such, each step in the aforementioned flow chart of FIG. 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

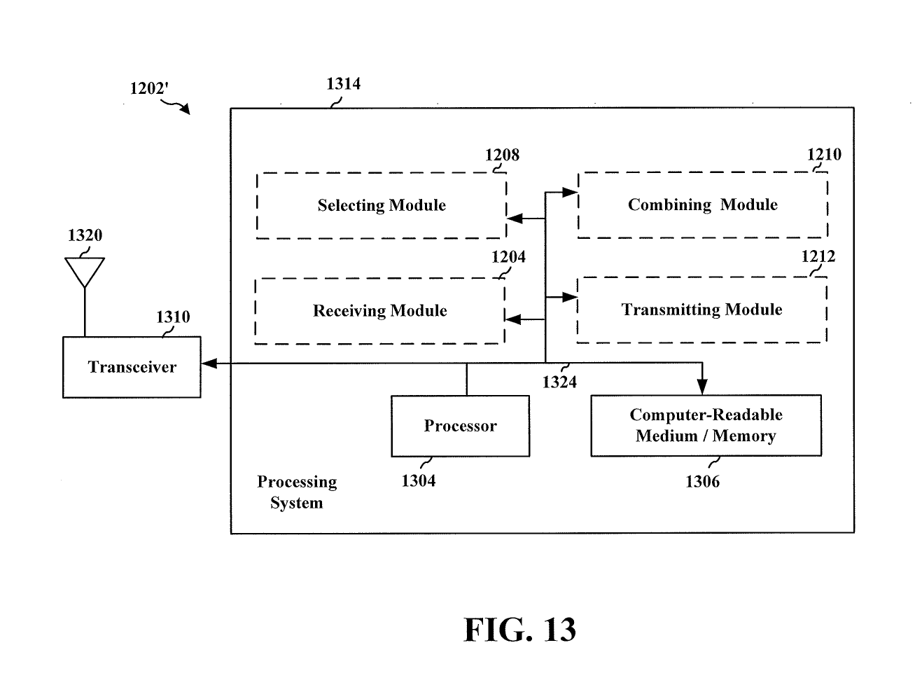

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1208, 1210, 1212, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically, the receiving module 1204. In addition, the transceiver 1310 receives information from the processing system 1314, specifically the transmission module 1212 and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system further includes at least one of the modules 1204, 1208, 1210, and 1212. The modules may be software modules running in the processor 1304, resident/stored in the computer readable medium/memory 1306, one or more hardware modules coupled to the processor 1304, or some combination thereof. In a case that the apparatus 1202′ is UE, the processing system 1314 may be a component of the UE 650 and may include the memory 660 and/or at least one of the TX processor 668, the RX processor 656, and the controller/processor 659.

In one configuration, the apparatus 1202/1202′ for wireless communication includes means for selecting at least two HARQ processes from among a plurality of HARQ processes within a round trip time, and means for combining the at least two selected HARQ processes to transmit the same data in a combined transmission. The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
selecting at least two hybrid automatic repeat request (HARQ) processes from among a plurality of HARQ processes within a round trip time; and
combining the at least two selected HARQ processes to transmit the same data in a combined transmission.

2. The method of claim 1, wherein at least one of the selected HARQ processes is a TTI-bundled HARQ process.

3. The method of claim 1, wherein the at least two selected HARQ processes are continuous within the round trip time.

4. The method of claim 1, wherein the at least two selected HARQ processes are offset within the round trip time.

5. The method of claim 4, wherein the offset between the at least two selected HARQ processes allows early termination of the combined transmission.

6. The method of claim 5, wherein an ACK of a first of the selected HARQ processes terminates the transmission of a second of the selected HARQ processes.

7. The method of claim 1, wherein selecting the at least two HARQ processes comprises receiving signaling indicating the at least two selected HARQ processes.

8. The method of claim 7, wherein the received signaling comprises upper layer signaling that explicitly identifies the at least two selected HARQ processes.

9. The method of claim 7, wherein the received signaling comprises a semi-persistent scheduling (SPS) activation signal and a first of the at least two selected HARQ processes corresponds to the HARQ process having a subframe in which the SPS activation occurred, and a second of the at least two selected HARQ processes is offset from the first selected HARQ process by an offset value.

10. The method of claim 9, wherein selecting further comprises:
receiving a grant for HARQ process through dynamic scheduling; and
overriding at least part of the HARQ process signal selection based on SPS.

11. The method of claim 1, wherein each HARQ process comprises a TTI-bundled HARQ process and the size of the bundle is a first size when uplink SPS is not configured and a second size when uplink SPS is configured.

12. The method of claim 1, wherein combining the at least two selected HARQ processes comprises:
receiving a downlink grant for a HARQ process; and
activating the at least two selected HARQ processes for the same data based on the downlink grant.

13. An apparatus for wireless communication, comprising:
means for selecting at least two hybrid automatic repeat request (HARQ) processes from among a plurality of HARQ processes within a round trip time; and
means for combining the at least two selected HARQ processes to transmit the same data in a combined transmission.

14. The apparatus of claim 13, wherein at least one of the selected HARQ processes is a TTI-bundled HARQ process.

15. The apparatus of claim 13, wherein the at least two selected HARQ processes are continuous within the round trip time.

16. The apparatus of claim 13, wherein the at least two selected HARQ processes are offset within the round trip time.

17. The apparatus of claim 16, wherein the offset between the at least two selected HARQ processes allows early termination of the combined transmission.

18. The apparatus of claim 17, wherein an ACK of a first of the selected HARQ processes terminates the transmission of a second of the selected HARQ processes.

19. The apparatus of claim 13, wherein the means for selecting the at least two HARQ processes is configured to receiving signaling indicating the at least two selected HARQ processes.

20. The apparatus of claim 19, wherein the received signaling comprises upper layer signaling that explicitly identifies the at least two selected HARQ processes.

21. The apparatus of claim 19, wherein the received signaling comprises a semi-persistent scheduling (SPS) activation signal and a first of the at least two selected HARQ processes corresponds to the HARQ process having a subframe in which the SPS activation occurred, and a second of the at least two selected HARQ processes is offset from the first selected HARQ process by an offset value.

22. The apparatus of claim 21, wherein the means for selecting is configured to:
receive a grant for HARQ process through dynamic scheduling; and
override at least part of the HARQ process signal selection based on SPS.

23. The apparatus of claim 13, wherein each HARQ process comprises a TTI-bundled HARQ process and the size of the bundle is a first size when uplink SPS is not configured and a second size when uplink SPS is configured.

24. The apparatus of claim 13, wherein the means for combining the at least two selected HARQ processes is configured to:
receive a downlink grant for a HARQ process; and
activate the at least two selected HARQ processes for the same data based on the downlink grant.

25. An apparatus for wireless communication, comprising:
a memory; and
at least one processor coupled to the memory and configured to:
select at least two hybrid automatic repeat request (HARQ) processes from among a plurality of HARQ processes within a round trip time; and
combine the at least two selected HARQ processes to transmit the same data in a combined transmission.

26. The apparatus of claim 25, wherein at least one of the selected HARQ processes is a TTI-bundled HARQ process.

27. The apparatus of claim 25, wherein the at least two selected HARQ processes are continuous within the round trip time.

28. The apparatus of claim 25, wherein the at least two selected HARQ processes are offset within the round trip time.

29. The apparatus of claim 25, wherein the at least one processor selects the at least two HARQ processes by being further configured to receive signaling indicating the at least two selected HARQ processes.

30. A computer program product stored on a computer-readable medium and comprising code that when executed on at least one processor causes the at least one processor to:
select at least two hybrid automatic repeat request (HARQ) processes from among a plurality of HARQ processes within a round trip time; and
combine the at least two selected HARQ processes to transmit the same data in a combined transmission
